(19) United States
(12) Patent Application Publication
(10) Pub. No.: US 2026/0212510 A1
(43) Pub. Date: Jul. 23, 2026

(54) IMAGE MEASUREMENT METHOD AND IMAGE PROCESSING DEVICE

(71) Applicant: Materials Analysis Technology Inc., HSINCHU COUNTY (TW)

(72) Inventors: Kuan-Chung Lin, Taipei City (TW); Yu-Wei Lin, New Taipei City (TW); Yu-Wei Chang, Hsinchu County (TW); Hui-Ling Yen, Taoyuan City (TW); Hung-Jen Chen, Hsinchu City (TW)

(73) Assignee: Materials Analysis Technology Inc., HSINCHU COUNTY (TW)

(21) Appl. No.: 19/077,044

(22) Filed: Mar. 11, 2025

(30) Foreign Application Priority Data
Jan. 20, 2025 (TW) 114102295

(51) Int. Cl. G06T 7/13; G06T 7/60; G06T 7/73

(52) U.S. Cl. CPC G06T 7/13; G06T 7/60; G06T 7/74; G06T 2207/20081; G06T 2207/20084; G06T 2207/20212

(57) ABSTRACT

The embodiments of the disclosure provide an image measurement method and an image processing device. The method comprises: obtaining an input image and a plurality of reference line segments in the input image; encoding the input image into a sequence vector, and integrating the sequence vector and a positional encoding vector into a first input vector; using a transformer encoder to generate a second input vector based on the first input; using a transformer decoder to generate a predicted offset result corresponding to each of a plurality of to-be-measured line segments based on the second input vector and query information; and generating a measurement result of each to-be-measured line segment based on the predicted offset result of each to-be-measured line segment.

### CROSS-REFERENCE TO RELATED APPLICATION

This application claims the priority benefit of Taiwan application serial no. 114102295 filed on Jan. 20, 2025. The entirety of the above-mentioned patent application is hereby incorporated by reference herein and made a part of this specification.

### BACKGROUND OF THE INVENTION

### 1. Field of the Invention

The disclosure relates to an image processing mechanism, and particularly to an image measurement method and an image processing device.

### 2. Description of Related Art

In traditional computer vision techniques, obtaining line segments composed of positions to be measured in an image typically relies on feature detection and matching techniques. However, these methods often struggle to guarantee stability and accuracy when processing images with high variability or complex backgrounds.

Moreover, when measurement targets need to be adjusted or changed, it typically requires a significant amount of time and resources to redesign and optimize the detection algorithms, thereby significantly increasing development costs and reducing efficiency.

### SUMMARY OF THE INVENTION

In view of this, the disclosure provides an image measurement method and an image processing device that may be utilized to solve the aforementioned technical problems.

The disclosure provides an image measurement method, executed by an image processing device, including: obtaining an input image and multiple reference line segments in the input image, wherein each of the reference line segments has a corresponding first endpoint position and second endpoint position, and the multiple reference line segments at least include multiple to-be-measured line segments; encoding the input image into a sequence vector, and integrating the sequence vector with a positional encoding vector to form a first input vector, wherein the positional encoding vector indicates the first endpoint position and the second endpoint position corresponding to each of the reference line segments; using a transformer encoder to generate a second input vector based on the first input vector; using a transformer decoder to generate a predicted offset result corresponding to each of the to-be-measured line segments based on the second input vector and query information, wherein the query information indicates descriptive information of each of the to-be-measured line segments; and generating a measurement result for each of the to-be-measured line segments based on the predicted offset result of each of the to-be-measured line segments.

The disclosure provides an image processing device, including a storage circuit and a processor. The storage circuit stores program code. The processor is coupled to the storage circuit and accesses the program code to execute: obtaining an input image and multiple reference line segments in the input image, wherein each of the reference line segments has a corresponding first endpoint position and second endpoint position, and the multiple reference line segments at least include multiple to-be-measured line segments; encoding the input image into a sequence vector, and integrating the sequence vector with a positional encoding vector to form a first input vector, wherein the positional encoding vector indicates the first endpoint position and the second endpoint position corresponding to each of the reference line segments; using a transformer encoder to generate a second input vector based on the first input vector; using a transformer decoder to generate a predicted offset result corresponding to each of the to-be-measured line segments based on the second input vector and query information, wherein the query information indicates descriptive information of each of the to-be-measured line segments; and generating a measurement result for each of the to-be-measured line segments based on the predicted offset result of each of the to-be-measured line segments.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 shows a schematic diagram of an image processing device according to an embodiment of the disclosure.

FIG. 2 shows a flowchart of an image measurement method according to an embodiment of the disclosure.

FIG. 3 shows a scenario application diagram according to an embodiment of the disclosure.

FIG. 4 shows a schematic diagram illustrating the offsetting of the first and second endpoint positions of each to-be-measured line segment according to FIG. 3.

FIG. 5 shows another scenario application diagram according to FIG. 3.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

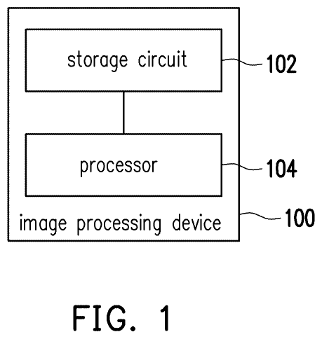

Please refer to FIG. 1, which shows a schematic diagram of an image processing device according to an embodiment of the disclosure. In different embodiments, the image processing device 100 may be implemented as various smart devices and/or computer devices, but the disclosure is not limited thereto.

In FIG. 1, the image processing device 100 includes a storage circuit 102 and a processor 104.

The storage circuit 102 may be, for example, any type of fixed or removable random access memory (RAM), read-only memory (ROM), flash memory, hard disk, or other similar devices or a combination of these devices, and may be used to store multiple codes or modules.

The processor 104 is coupled to the storage circuit 102 and may be a general-purpose processor, special-purpose processor, conventional processor, digital signal processor, multiple microprocessors, one or more microprocessors combined with digital signal processor cores, controller, microcontroller, Application Specific Integrated Circuit (ASIC), Field Programmable Gate Array (FPGA), any other type of integrated circuit, state machine, Advanced RISC Machine (ARM)-based processor, and the like.

In the embodiments of the disclosure, the processor 104 may access the modules and codes stored in the storage circuit 102 to implement the image measurement method proposed by the disclosure, the details of which are described as follows.

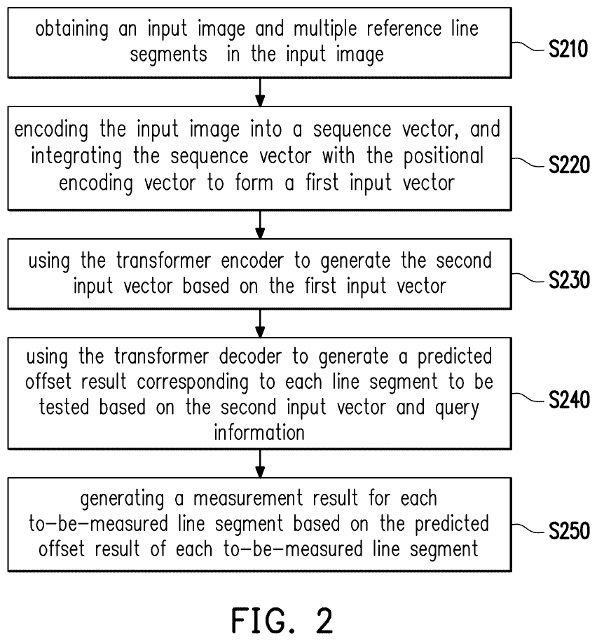

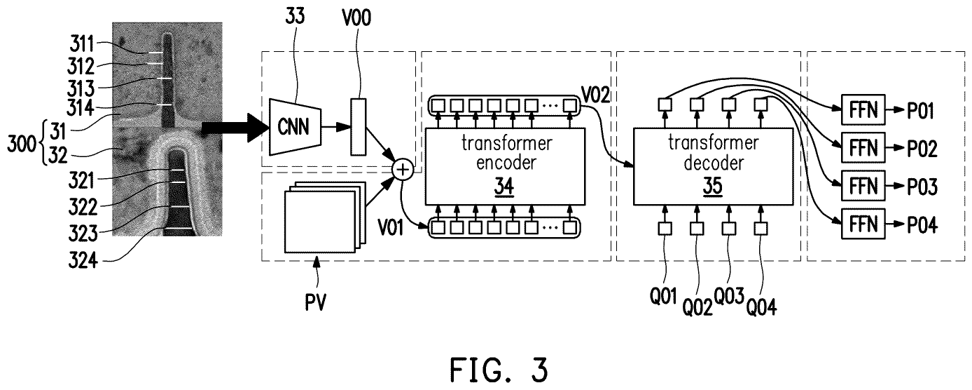

Please refer to FIG. 2, which shows a flowchart of an image measurement method according to an embodiment of the disclosure. The method of this embodiment may be executed by the image processing device 100 shown in FIG. 1. The details of each step in FIG. 2 will be explained in conjunction with the components shown in FIG. 1. To make the concept of the embodiment of the disclosure easier to understand, FIG. 3 is also used for explanation, where FIG. 3 shows a scenario application diagram according to an embodiment of the disclosure.

In step S210, the processor 104 obtains an input image 300 and multiple reference line segments 311-314, 321-324 in the input image 300, where the reference line segments 311-314, 321-324 at least include multiple to-be-measured line segments.

In the scenario of FIG. 3, the input image 300 includes a spliced image composed of a target image 31 to be measured and an auxiliary image 32, where the target image 31 and the auxiliary image 32 may be, for example, spliced vertically to form the input image 300 (i.e., the spliced image). In other embodiments, the target image 31 and the auxiliary image 32 may also be spliced by other approaches to form the corresponding spliced image, but the disclosure is not limited thereto.

In FIG. 3, the reference line segments 311-314, 321-324 include multiple to-be-measured line segments and multiple auxiliary line segments, where the multiple to-be-measured line segments include, for example, the reference line segments 311-314 located in the target image 31, and the multiple auxiliary line segments include, for example, the reference line segments 321-324 located in the auxiliary image 32.

In one embodiment, each to-be-measured line segment (for example, reference line segments 311-314) may be, for instance, a first line segment randomly assigned in the target image 31. In the scenario of FIG. 3, the target image 31 may correspond to an image of a FinFET (Fin Field-Effect Transistor). In one embodiment, certain parts (or widths) of the FinFET in the target image 31 may be, for example, the targets that need to be measured.

In one embodiment, the position and/or length of each to-be-measured line segment (for example, reference line segments 311-314) may be randomly set, or set by a designer according to certain principles, but the disclosure is not limited thereto.

In FIG. 3, each auxiliary line segment (for example, reference line segments 321-324) may be a second line segment indicating the corresponding target length in the auxiliary image 32. In the scenario of FIG. 3, the auxiliary image 32 may correspond to an image of another FinFET, and the actual lengths (or widths) of certain parts of this FinFET may be indicated by the corresponding auxiliary line segments (for example, reference line segments 321-324).

In other embodiments, the number of to-be-measured line segments in the target image 31 and the number of auxiliary line segments in the auxiliary image 32 may be set according to the designer's requirements, and are not limited to the pattern shown in FIG. 3.

In one embodiment, each of the reference line segments 311-314, 321-324 has a corresponding first endpoint position (for example, left endpoint position) and second endpoint position (for example, right endpoint position).

In step S220, the processor 104 encodes the input image 300 into a sequence vector V00, and integrates the sequence vector V00 with the positional encoding vector PV to form a first input vector V01.

In FIG. 3, the processor 104 may, for example, feed the input image 300 into a convolutional neural network (CNN) 33, to extract features of the input image 300 as the sequence vector V01 by the CNN 33, but the disclosure is not limited thereto.

In one embodiment, the positional encoding vector PV may indicate the corresponding first endpoint position and second endpoint position of each reference line segment 311-314, 321-324.

Taking reference line segment 311 as an example, its corresponding first endpoint position and second endpoint position may be represented as the pixel coordinates of the left and right endpoints of reference line segment 311 in the target image 31. Taking reference line segment 312 as an example, its corresponding first endpoint position and second endpoint position may be represented as the pixel coordinates of the left and right endpoints of reference line segment 312 in the target image 31. Taking reference line segment 313 as an example, its corresponding first endpoint position and second endpoint position may be represented as the pixel coordinates of the left and right endpoints of reference line segment 313 in the target image 31. Taking reference line segment 314 as an example, its corresponding first endpoint position and second endpoint position may be represented as the pixel coordinates of the left and right endpoints of reference line segment 314 in the target image 31.

Taking reference line segment 321 as an example, its corresponding first endpoint position and second endpoint position may be represented as the pixel coordinates of the left and right endpoints of reference line segment 321 in the auxiliary image 32. Taking reference line segment 322 as an example, its corresponding first endpoint position and second endpoint position may be represented as the pixel coordinates of the left and right endpoints of reference line segment 322 in the auxiliary image 32. Taking reference line segment 323 as an example, its corresponding first endpoint position and second endpoint position may be represented as the pixel coordinates of the left and right endpoints of reference line segment 323 in the auxiliary image 32. Taking reference line segment 324 as an example, its corresponding first endpoint position and second endpoint position may be represented as the pixel coordinates of the left and right endpoints of reference line segment 324 in the auxiliary image 32.

In this scenario, the positional encoding vector PV in FIG. 3 may, for example, indicate the pixel coordinates of the individual left and right endpoints of reference line segments 311-314 in the target image 31, as well as the pixel coordinates of the individual left and right endpoints of reference line segments 321-324 in the auxiliary image 32, but the disclosure is not limited thereto.

In some embodiments, the aforementioned pixel coordinates may be presented as corresponding vectors in the positional encoding vector PV after undergoing certain transformations, but the disclosure is not limited thereto.

In one embodiment, the processor 104 may, after obtaining the sequence vector V00 and the positional encoding vector PV, integrate the sequence vector V00 with the positional encoding vector PV to form the first input vector V01.

In some embodiments, the processor 104 may, for example, utilize any existing approach to integrate the sequence vector V00 with the positional encoding vector PV to form the first input vector V01 (e.g., concatenation), but the disclosure is not limited thereto.

In step S230, the processor 104 uses the transformer encoder 34 to generate the second input vector V02 based on the first input vector V01.

In one embodiment, the transformer encoder 34 is, for example, the transformer encoder in the detection transformer (DETR) model, and its detailed operational principles may be referred to in existing technical literature related to the DETR model, which will not be elaborated here.

In some embodiments, the second input vector V02 is, for example, a feature matrix that has undergone global context modeling by the transformer encoder 34. This data may include spatial structure and semantic information, but the disclosure is not limited thereto.

In step S240, the processor 104 uses the transformer decoder 35 to generate a predicted offset result P01-P04 corresponding to each to-be-measured line segment based on the second input vector V02 and query information Q01-Q04, where the query information Q01-Q04 indicates descriptive information for each to-be-measured line segment.

In one embodiment, the descriptive information for each to-be-measured line segment may include semantic embedding vectors corresponding to the name of each to-be-measured line segment. For example, assuming the names of the reference line segments 311-314 (i.e., the to-be-measured line segments illustrated in FIG. 3) are “To-be-measured line segment 1”, “To-be-measured line segment 2”, “To-be-measured line segment 3”, and “To-be-measured line segment 4” respectively, the processor 104 may, for instance, input these names individually into the Bidirectional Encoder Representations from Transformers (BERT) to generate semantic embedding vectors corresponding to the names of each to-be-measured line segment by BERT. In this case, the semantic embedding vectors corresponding to the names of each to-be-measured line segment may be determined as query information Q01-Q04 respectively, but the disclosure is not limited thereto.

In one embodiment, the transformer decoder 35 is, for example, the transformer decoder in the DETR model, and its detailed operational principles may also be referred to in existing technical literature related to the DETR model, which will not be elaborated here.

In one embodiment, the multiple to-be-measured line segments (for example, reference line segments 311-314) include a first to-be-measured line segment (which is, for example, any one of the to-be-measured line segments), and the predicted offset result corresponding to the first to-be-measured line segment includes a first offset and a second offset, where the first offset corresponds to the first endpoint position of the first to-be-measured line segment, and the second offset corresponds to the second endpoint position of the first to-be-measured line segment.

Taking reference line segment 311 as an example, its corresponding predicted offset result P01 may include a first offset corresponding to the first endpoint position of reference line segment 311 and a second offset corresponding to the second endpoint position of reference line segment 311. Taking reference line segment 312 as an example, its corresponding predicted offset result P02 may include a first offset corresponding to the first endpoint position of reference line segment 312 and a second offset corresponding to the second endpoint position of reference line segment 312. Taking reference line segment 313 as an example, its corresponding predicted offset result P03 may include a first offset corresponding to the first endpoint position of reference line segment 313 and a second offset corresponding to the second endpoint position of reference line segment 313. Taking reference line segment 314 as an example, its corresponding predicted offset result P04 may include a first offset corresponding to the first endpoint position of reference line segment 314 and a second offset corresponding to the second endpoint position of reference line segment 314, but the disclosure is not limited thereto.

In one embodiment, each of the aforementioned first offsets may, for example, include a vertical offset component and a horizontal offset component associated with the corresponding first endpoint position. Similarly, each of the aforementioned second offsets may, for example, include a vertical offset component and a horizontal offset component associated with the corresponding second endpoint position, but the disclosure is not limited thereto.

In one embodiment, the components corresponding to the dashed box in FIG. 3 may be integrally understood as a variant of a DETR model. To enable the shown variant of the DETR model to provide the aforementioned capability (for example, generating predicted offset results P01-P04 in response to the input image 300), during the relevant training process of the DETR model in FIG. 3, specially designed training data may be fed into the DETR model in FIG. 3 to allow the DETR model in FIG. 3 to perform corresponding learning.

In some embodiments, the training data may include, for example, other images with similar properties to the input image 300. That is, each piece of training data may also be a spliced image formed by splicing together 2 FinFET images (one may correspond to the image to be measured, and the other may correspond to the auxiliary image), and multiple auxiliary line segments and multiple to-be-measured line segments may be annotated therein. The annotated auxiliary line segments may, for example, indicate line segments of corresponding target lengths in the FinFET image (such as the width at certain specific positions on the FinFET), while the annotated to-be-measured line segments may also be multiple randomly assigned line segments, but the disclosure is not limited thereto.

Moreover, each piece of training data may also include offset results that can offset the corresponding to-be-measured line segments to appropriate positions.

Based on this, after feeding the aforementioned training data into the DETR model in FIG. 3 under training, the DETR model in FIG. 3 may learn how to correctly offset the to-be-measured line segments to appropriate positions. Accordingly, when an input image marked with one or more to-be-measured line segments is fed into the trained DETR model in FIG. 3, the DETR model in FIG. 3 may correspondingly predict/determine how to offset the first and second position endpoints of each to-be-measured line segment in order to correctly measure the corresponding target length, and thus determine the corresponding predicted offset results, but the disclosure is not limited thereto.

In step S250, the processor 104 generates a measurement result for each to-be-measured line segment (for example, reference line segments 311-314) based on the predicted offset result P01-P04 of each to-be-measured line segment.

Taking the first to-be-measured line segment as an example again, the processor 104 may, for instance, offset the first endpoint position of the first to-be-measured line segment according to the corresponding first offset, and offset the second endpoint position of the first to-be-measured line segment according to the corresponding second offset. Subsequently, the processor 104 may determine the distance between the offset first endpoint position and the offset second endpoint position of the first to-be-measured line segment, and determine this distance as the measurement result corresponding to the first to-be-measured line segment.

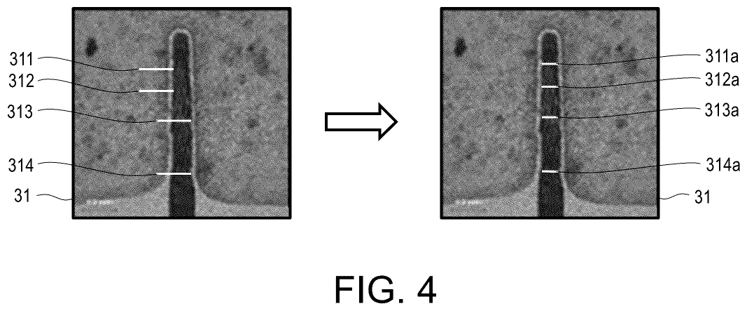

Please refer to FIG. 4, which shows a schematic diagram illustrating the offset of the first and second endpoint positions of each to-be-measured line segment according to FIG. 3.

In FIG. 4, the processor 104 may, for example, offset the first endpoint position (e.g., the left endpoint position) of the reference line segment 311 according to the first offset in the predicted offset result P01 to form the first endpoint position (e.g., the left endpoint position) of the reference line segment 311a. Additionally, the processor 104 may, for example, offset the second endpoint position (e.g., the right endpoint position) of the reference line segment 311 according to the second offset in the predicted offset result P01 to form the second endpoint position (e.g., the right endpoint position) of the reference line segment 311a.

Subsequently, the processor 104 may then determine the distance between the first endpoint position and the second endpoint position of the reference line segment 311a, to serve as the measurement result corresponding to the reference line segment 311a (or reference line segment 311).

Furthermore, the processor 104 may, for example, offset the first endpoint position (e.g., the left endpoint position) of the reference line segment 312 according to the first offset in the predicted offset result P02 to form the first endpoint position (e.g., the left endpoint position) of the reference line segment 312a. Additionally, the processor 104 may, for example, offset the second endpoint position (e.g., the right endpoint position) of the reference line segment 312 according to the second offset in the predicted offset result P02 to form the second endpoint position (e.g., the right endpoint position) of the reference line segment 312a.

Subsequently, the processor 104 may then determine the distance between the first endpoint position and the second endpoint position of the reference line segment 312a, to serve as the measurement result corresponding to the reference line segment 312a (or reference line segment 312).

For the reference line segments 313 and 314, the processor 104 may determine the corresponding reference line segments 313a, 314a and their corresponding measurement results according to the aforementioned description. The details of this process are not repeated here.

From the above, it can be seen that the embodiment of the disclosure uses a modified DETR architecture for line segment adjustment, which can effectively capture and analyze the line segment features and their corresponding relationships in the target image 31 and the auxiliary image 32. By this means, the image processing device 100 can not only learn the line segment configuration in a single image (e.g., the auxiliary image 32) but also automatically deduce the optimal mapping position of corresponding line segments in another image (e.g., the target image 31), thereby achieving precise and automated line segment translation. This innovative approach not only improves processing speed and flexibility but can also be applied to fine-tuning line segments in the same image.

It should be understood that although the input image 300 considered in the scenario of FIG. 3 is a composite image formed by concatenating the target image 31 and the auxiliary image 32, in other embodiments, the method proposed by this embodiment of the disclosure may also be applicable to an input image that only includes the target image 31.

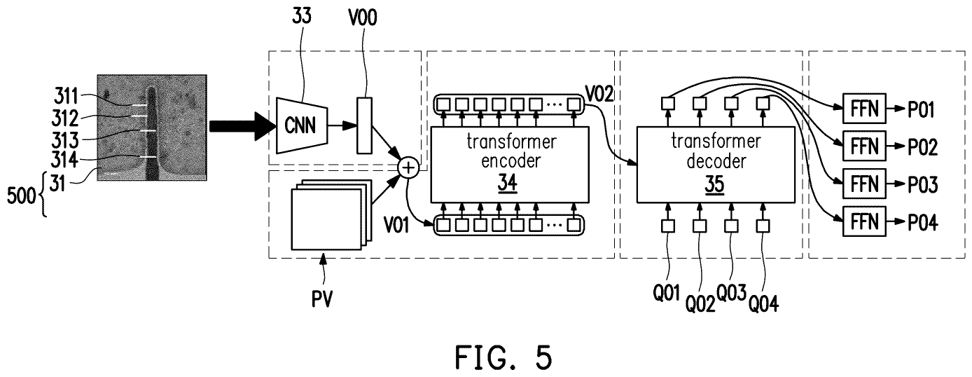

Please refer to FIG. 5, which shows another application scenario diagram according to FIG. 3. In the scenario of FIG. 5, the input image 500 under consideration only includes the target image 31. In this case, the reference line segments 311 to 314 are composed only of to-be-measured line segments, and each to-be-measured line segment is a first line segment randomly assigned in the target image 31.

Based on this, the processor 104 may perform step S220 based on the input image 500 and the reference line segments 311 to 314 therein. In step S220, the processor 104 may encode the input image 500 into a sequence vector V00, and integrate the sequence vector V00 with the positional encoding vector PV to form the first input vector V01.

In the scenario of FIG. 5, the positional encoding vector PV may correspondingly only indicate the first endpoint position and the second endpoint position corresponding to each to-be-measured line segment (i.e., reference line segments 311 to 314), but the disclosure is not limited thereto.

Subsequently, the processor 104 may continue to execute steps S230 to S240, and the details of each step can be referred to in the relevant descriptions of FIG. 3 and FIG. 4, which will not be repeated here.

In one embodiment, the various components corresponding to the dashed box in FIG. 5 may be integrally understood as a variant of a DETR model. To enable the shown variant of the DETR model to provide the aforementioned capabilities (e.g., generating predicted offset results P01 to P04 in response to the input image 500), during the relevant training process of the DETR model in FIG. 5, specially designed training data may be fed into the DETR model in FIG. 5, to allow the DETR model in FIG. 5 to perform corresponding learning.

In some embodiments, the training data may include, for example, other images that have similar properties to the input image 500. That is, each piece of training data may also be a FinFET image, and may be annotated with multiple to-be-measured line segments, where these to-be-measured line segments may be randomly assigned line segments, but the disclosure is not limited thereto.

Moreover, each piece of training data may also include offset results that can offset the corresponding to-be-measured line segments to appropriate positions.

Based on this, after feeding the aforementioned training data into the DETR model in FIG. 5 during training, the DETR model in FIG. 5 may learn how to correctly offset the to-be-measured line segments to appropriate positions. Accordingly, when an input image marked with one or more to-be-measured line segments is fed into the trained DETR model in FIG. 5, the DETR model in FIG. 5 may correspondingly predict/determine how to offset the first and second endpoint positions of each to-be-measured line segment to correctly measure the corresponding target length, and thus determine the corresponding predicted offset results, but the disclosure is not limited thereto.

It should be understood that although the above embodiments all use FinFET images as illustrative examples, they are only used for exemplification and are not intended to limit the possible implementations of the disclosure. For scenarios that require measurements in other types of images, the methods proposed by the embodiments of the disclosure may all operate based on similar principles to achieve the required measurements.

In summary, the embodiments of the disclosure propose a novel end-to-end automated image measurement method. This image measurement method directly processes the entire workflow from image recognition to measurement line segment mapping within the model, not only eliminating cumbersome post-processing steps, but also avoiding the high costs of retraining and redesigning post-processing when requirements change.

Furthermore, the DETR variant structure of the embodiments of the disclosure enables the model to flexibly adapt to various measurement tasks. Unlike traditional methods that rely on explicit object definition and feature extraction, this technique uses deep learning to naturally learn the associations between images and measurement line segments, theoretically capable of covering all future scenarios that may require measurement. This design not only reduces the model's dependence on specific scenarios but also enhances its adaptability to new and changing tasks.

Moreover, due to the high degree of automation and versatility of the embodiments of the disclosure, the technology of this disclosure may be widely applied in various practical scenarios, such as industrial automation, medical image analysis, remote sensing image processing, etc. After obtaining sufficient training data, the model can perform accurate measurements on new images without further adjustments, greatly reducing operational complexity and costs, and improving work efficiency.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An image measurement method, executed by an image processing device, comprising:
obtaining an input image and a plurality of reference line segments in the input image, wherein each of the reference line segments has a corresponding first endpoint position and second endpoint position, and the plurality of reference line segments at least comprise a plurality of to-be-measured line segments;
encoding the input image into a sequence vector, and integrating the sequence vector with a positional encoding vector to form a first input vector, wherein the positional encoding vector indicates the first endpoint position and the second endpoint position corresponding to each of the reference line segments;
using a transformer encoder to generate a second input vector based on the first input vector;
using a transformer decoder to generate a predicted offset result corresponding to each of the to-be-measured line segments based on the second input vector and query information, wherein the query information indicates descriptive information of each of the to-be-measured line segments; and
generating a measurement result for each of the to-be-measured line segments based on the predicted offset result of each of the to-be-measured line segments.

2. The method as claimed in claim 1, wherein the input image comprises a target image to be measured, and the plurality of reference line segments only comprise the plurality of to-be-measured line segments, and each of the to-be-measured line segments is a first line segment randomly assigned in the target image.

3. The method as claimed in claim 1, wherein the input image comprises a spliced image formed by splicing a target image to be measured and an auxiliary image, the plurality of reference line segments comprise the plurality of to-be-measured line segments and a plurality of auxiliary line segments, each of the to-be-measured line segments is a first line segment randomly assigned in the target image, and each of the auxiliary line segments is a second line segment indicating a corresponding target length in the auxiliary image.

4. The method as claimed in claim 1, wherein encoding the input image into the sequence vector comprises:
inputting the input image into a convolutional neural network, to extract features of the input image by the convolutional neural network as the sequence vector.

5. The method as claimed in claim 1, wherein the descriptive information of each of the to-be-measured line segments comprises a semantic embedding vector corresponding to a name of each of the to-be-measured line segments.

6. The method as claimed in claim 1, wherein the plurality of to-be-measured line segments comprise a first to-be-measured line segment, and the predicted offset result corresponding to the first to-be-measured line segment comprises a first offset and a second offset, wherein the first offset corresponds to the first endpoint position of the first to-be-measured line segment, and the second offset corresponds to the second endpoint position of the first to-be-measured line segment.

7. The method as claimed in claim 6, wherein generating the measurement result for each of the to-be-measured line segments based on the predicted offset result of each of the to-be-measured line segments comprises:
offsetting the first endpoint position of the first to-be-measured line segment according to the first offset, and offsetting the second endpoint position of the first to-be-measured line segment according to the second offset;
determining a distance between the offset first endpoint position and the offset second endpoint position of the first to-be-measured line segment, and determining the distance as the measurement result corresponding to the first to-be-measured line segment.

8. An image processing device, comprising:
a non-transitory storage circuit, storing a program code; and
a processor, coupled to the non-transitory storage circuit and configured by the program code to execute:
obtaining an input image and a plurality of reference line segments in the input image, wherein each of the reference line segments has a corresponding first endpoint position and second endpoint position, and the plurality of reference line segments comprise at least a plurality of to-be-measured line segments;
encoding the input image into a sequence vector, and integrating the sequence vector with a positional encoding vector into a first input vector, wherein the positional encoding vector indicates the first endpoint position and the second endpoint position corresponding to each of the reference line segments;
using a transformer encoder to generate a second input vector based on the first input vector;
using a transformer decoder to generate a predicted offset result corresponding to each of the to-be-measured line segments based on the second input vector and query information, wherein the query information indicates descriptive information of each of the to-be-measured line segments; and
generating a measurement result for each of the to-be-measured line segments based on the predicted offset result of each of the to-be-measured line segments.
